(19) United States
(12) Patent Application Publication
(10) Pub. No.: US 2020/0226534 A1
(43) Pub. Date: Jul. 16, 2020

(54) SYSTEMS AND METHODS FOR EVALUATING A SCHEDULING STRATEGY ASSOCIATED WITH DESIGNATED DRIVING SERVICES

(71) Applicant: BEIJING DIDI INFINITY TECHNOLOGY ANDDEVELOPMENT CO., LTD., Beijing (CN)

(72) Inventor: Ruifei YANG, Beijing (CN)

(73) Assignee: BEIJING DIDI INFINITY TECHNOLOGY AND DEVELOPMENT CO., LTD., Beijing (CN)

(21) Appl. No.: 16/831,936

(22) Filed: Mar. 27, 2020

Related U.S. Application Data
(63) Continuation of application No. PCT/CN2017/103895, filed on Sep. 28, 2017.

(51) Int. Cl. G06Q 10/06; G08G 1/127

(52) U.S. Cl. CPC G06Q 10/063116; G06Q 10/0633; G08G 1/127

(57) ABSTRACT

The present disclosure relates to systems and methods for scheduling service of an on-demand service. The systems may perform the methods to obtain historical service information of the on-demand service associated with a target region; determine a scheduling strategy to schedule service providers to the target region based on the historical service information; determine estimated service information associated with the target region based on the scheduling strategy and the historical service information; determine that the scheduling strategy has a better service providing result than the historical service information; and store the scheduling strategy in at least one storage medium.

### CROSS-REFERENCE TO RELATED APPLICATIONS

This application is a continuation of International Application No. PCT/CN2017/103895, filed on Sep. 28, 2017, which designates the United States of America, the contents of which are incorporated herein by reference in their entirety.

### TECHNICAL FIELD

The present disclosure generally relates to systems and methods for on-demand services, and in particular, to systems and methods for evaluating a scheduling strategy associated with designated driving services.

### BACKGROUND

On-demand transportation services (e.g., a designated driving service) utilizing Internet technology have become increasingly popular because of their convenience. For an area where a large number of service requests are initiated, a system providing on-demand transportation services may determine a scheduling strategy and send service providers to the area based on the scheduling strategy. However, in some situations, the demands for on-demand transportation services at different individual areas may be different, and accordingly, the system should determine a suitable scheduling strategy to improve service providing result.

### SUMMARY

According to one aspect of the present disclosure, a system is provided. The system may include at least one storage medium including a set of instructions for scheduling service of an on-demand service and at least one processor in communication with the at least one storage medium. When executing the set of instructions, the at least one processor may be configured to cause the system to perform one or more of the following operations. The system may obtain historical service information of the on-demand service associated with a target region. The system may determine a scheduling strategy to schedule service providers to the target region based on the historical service information. The system may determine estimated service information associated with the target region based on the scheduling strategy and the historical service information. The system may determine that the scheduling strategy has a better service providing result than the historical service information. The system may store the scheduling strategy in the at least one storage medium.

In some embodiments, the historical service information may include at least one of a number of cancelled historical service requests in the target region, a number of historical service requests with no response in the target region, and/or a number of completed historical service requests in the target region.

In some embodiments, the estimated service information may include at least one of a simulated number of cancelled service requests in the target region, a simulated number of service requests with no response in the target region, and/or a simulated number of completed service requests in the target region.

In some embodiments, the system may determine at least one of a first difference between the simulated number of cancelled service requests and a number of historical cancelled service requests, a second difference between a simulated number of service requests with no response and the number of historical service requests with no response, and/or a third difference between the simulated number of completed service requests and the number of completed historical service requests.

In some embodiments, the system may determine a weighted value of at least two of the first difference, the second difference, and/or the third difference. The system may determine the better service providing result based on the weighted value.

In some embodiments, the system may rank at least two of the first difference, the second difference, and/or the third difference. The system may select one of the ranked at least two of the first difference, the second difference, and/or the third difference. The system may determine the better service providing result based on the selected one of the first difference, the second difference, and/or the third difference.

In some embodiments, the system may determine whether the simulated number of cancelled service requests is less than the number of cancelled historical service requests. In response to the determination that the simulated number of cancelled service requests is less than the number of cancelled historical service requests, the system may determine the that the scheduling strategy has the better service providing result than the historical service information.

In some embodiments, the system may determine whether the simulated number of service requests with no response is less than the number of historical service requests with no response. In response to the determination that the simulated number of service requests with no response is less than the number of historical service requests with no response, the system may determine the that the scheduling strategy has the better service providing result than the historical service information.

In some embodiments, the system may determine whether the simulated number of completed service requests is larger than the number of completed historical service requests. In response to the determination that the simulated number of completed service requests is larger than the number of completed historical service requests, the system may determine the that the scheduling strategy has the better service providing result than the historical service information.

In some embodiments, the on-demand service may be a designated driving service.

In some embodiments, the designated driving service may be a service that allows a service requestor to online designate a service provider, so that the service provider could come to the service requestor's place and use the service requestor's equipment to provide the service.

According to another aspect of the present disclosure, a method is provided. The method may be implemented on a computing device having at least one processor, at least one storage medium, and a communication platform connected to a network. The method may include obtaining historical service information of the on-demand service associated with a target region; determining a scheduling strategy to schedule service providers to the target region based on the historical service information; determining estimated service information associated with the target region based on the scheduling strategy and the historical service information; determining that the scheduling strategy has a better service providing result than the historical service information; and storing the scheduling strategy in the at least one storage medium.

In some embodiments, the determining that the scheduling strategy has a better service providing result than the historical service information may include determining at least one of a first difference between the simulated number of cancelled service requests and a number of historical cancelled service requests, a second difference between a simulated number of service requests with no response and the number of historical service requests with no response, and/or a third difference between the simulated number of completed service requests and the number of completed historical service requests.

In some embodiments, the determining that the scheduling strategy has a better service providing result than the historical service information may include determining a weighted value of at least two of the first difference, the second difference, and/or the third difference; and determining the better service providing result based on the weighted value.

In some embodiments, the determining that the scheduling strategy has a better service providing result than the historical service information may include ranking at least two of the first difference, the second difference, and/or the third difference; selecting one of the ranked at least two of the first difference, the second difference, and/or the third difference; and determining the better service providing result based on the selected one of the first difference, the second difference, and/or the third difference.

In some embodiments, the determining that the scheduling strategy has a better service providing result than the historical service information may include determining whether the simulated number of cancelled service requests is less than the number of cancelled historical service requests; and in response to the determination that the simulated number of cancelled service requests is less than the number of cancelled historical service requests, determining the that the scheduling strategy has the better service providing result than the historical service information.

In some embodiments, the determining that the scheduling strategy has a better service providing result than the historical service information may include determining whether the simulated number of service requests with no response is less than the number of historical service requests with no response; and in response to the determination that the simulated number of service requests with no response is less than the number of historical service requests with no response, determining the that the scheduling strategy has the better service providing result than the historical service information.

In some embodiments, the determining that the scheduling strategy has a better service providing result than the historical service information may include determining whether the simulated number of completed service requests is larger than the number of completed historical service requests; and in response to the determination that the simulated number of completed service requests is larger than the number of completed historical service requests, determining the that the scheduling strategy has the better service providing result than the historical service information.

According to yet another aspect of the present disclosure, a non-transitory computer-readable storage medium is provided. The non-transitory computer-readable storage medium may include a set of instructions for scheduling service of an on-demand service. When the set of instructions is executed by at least one processor, the set of instructions may cause the storage medium to effectuate a method. The method may include obtaining historical service information of the on-demand service associated with a target region; determining a scheduling strategy to schedule service providers to the target region based on the historical service information; determining estimated service information associated with the target region based on the scheduling strategy and the historical service information; determining that the scheduling strategy has a better service providing result than the historical service information; and storing the scheduling strategy in the non-transitory computer-readable storage medium.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary on-demand service system according to some embodiments of the present disclosure;

FIG. 2 is a schematic diagram illustrating an exemplary computing device according to some embodiments of the present disclosure;

FIG. 3 is a block diagram illustrating an exemplary processing engine according to some embodiments of the present disclosure;

FIG. 4 is a flowchart illustrating an exemplary process for evaluating a scheduling strategy associated with a designated driving service according to some embodiments of the present disclosure;

FIG. 5 is a block diagram illustrating an exemplary evaluation module according to some embodiments of the present disclosure; and

FIG. 6-A and FIG. 6-B are a schematic diagrams illustrating an exemplary scheduling strategy according to some embodiments of the present disclosure.

### DETAIL DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure, and the combination of parts and economies of manufacture, may become more apparent upon consideration of the following description with reference to the accompanying drawings, all of which form part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding on-demand transportation service, it should also be understood that this is only one exemplary embodiment. The system or method of the present disclosure may be applied to any other kind of on demand service. For example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high-speed rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express. The application of the system or method of the present disclosure may include a webpage, a plug-in of a browser, a client terminal, a custom system, an internal analysis system, an artificial intelligence robot, or the like, or any combination thereof.

The terms “passenger,” “requestor,” “service requestor,” and “customer” in the present disclosure are used interchangeably to refer to an individual, an entity that may request or order a service. Also, the terms “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity that may request a service, order a service, provide a service, or facilitate the providing of the service. For example, the user may be a passenger, a driver, an operator, or the like, or any combination thereof. In the present disclosure, terms “passenger,” “user equipment,” “user terminal,” and “passenger terminal” may be used interchangeably, and terms “driver” and “driver terminal” may be used interchangeably.

The terms “request,” and “service request” in the present disclosure are used interchangeably to refer to a request that may be initiated by a passenger, a requestor, a service requestor, a customer, a driver, a provider, a service provider, a supplier, or the like, or any combination thereof. The service request may be accepted by any one of a passenger, a requestor, a service requestor, a customer, a driver, a provider, a service provider, or a supplier. The service request may be chargeable or free.

The positioning technology used in the present disclosure may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning technologies may be used interchangeably in the present disclosure.

An aspect of the present disclosure relates to systems and methods for evaluating a scheduling strategy of a designated driving service, a service that a passenger designates and/or hire a driver to drive the passenger's vehicle on behalf of the passenger. For a specific region, when the demand for designated driving services is relatively high, the systems and methods may determine a scheduling strategy and schedule available service providers (e.g., drivers) to the region to meet the high demand. In order to determine a suitable scheduling strategy for the region, the systems and methods may evaluate a plurality of scheduling strategies and select one from the plurality of scheduling strategies based on the evaluation result.

For example, the systems and methods may obtain historical records of the number of cancelled historical service requests in the region. The systems and methods may further determine a simulated number of cancelled service requests corresponding to a scheduling strategy based on the historical records. When the simulated number of cancelled service requests is less than the number of cancelled historical service requests, the scheduling strategy may be a better strategy to recommend to drivers.

With the development of Internet technology, designated driving services have become increasingly popular. For example, when a user is unable to drive because of drinking or discomfort, he/she can initiate a designated driving service request to an online service platform and receive the service after the online platform allocates the service request to a driver. Generally, service demands in different regions and/or in different time periods are different. Take a specific region with a relatively high service demand (referred to as a “busy region”) as an example, the online service platform should determine a suitable scheduling strategy and schedule drivers from non-busy regions to the busy region based on the scheduling strategy. However, different scheduling strategies may have different effects, if an optimal scheduling strategy can be determined in advance, the relatively high service demand in the busy region can be well alleviated. According to the systems and methods of the present disclosure, a scheduling strategy can be evaluated based on a simulation method, under which a service providing effect can be simulated, for example, a simulated count of cancelled service requests in the busy region, a simulated count of service requests with no response in the busy region, a simulated count of completed service requests in the busy region, etc. Accordingly, an optimal scheduling strategy can be determined and applied to the busy region, thereby improving the scheduling effect and user experience. That is, the present invention is able to improve the validity and accuracy of the service scheduling, thereby relieving data interaction pressure of the online on-demand transportation service system or platform, reducing power consumption of requester terminals, provider terminals, and the online on-demand transportation service platform, and protecting privacy of the service requesters.

It should be noted that online on-demand transportation service (e.g., online taxi hailing, deginated driving service), is a new form of service rooted only in post-Internet era. It provides technical solutions to users (e.g., service requestors) and service providers (e.g., drivers) that could raise only in post-Internet era. In pre-Internet era, the highly customized service of designate driving service is only available between 2 people that know each other. It is impossible for a passenger to call someone miles away to drive for him. Online designated driving service, however, allows a user of the service to real-time and automatic distribute a service request to a vast number of individual service providers (e.g., a chauffeur (also referred to as a designated driver)) distance away from the user. It also allows a plurality of service providers to respond to the service request simultaneously and in real-time. Therefore, through the Internet, the online on-demand transportation systems may provide a much more efficient transaction platform for the users and the service providers that may never meet in a traditional pre-Internet transportation service system.

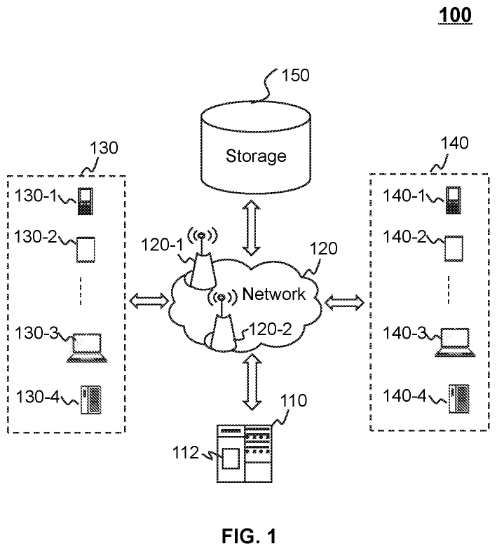

FIG. 1 is a schematic diagram illustrating an exemplary on-demand service system 100 according to some embodiments of the present disclosure. For example, the on-demand service system 100 may be an online transportation service platform for transportation services such as taxi hailing, chauffeur services, delivery vehicles, express car, carpool, bus service, driver hiring and shuttle services. The on-demand service system 100 may be an online platform including a server 110, a network 120, a requestor terminal 130, a provider terminal 140, and a storage 150. The server 110 may include a processing engine 112.

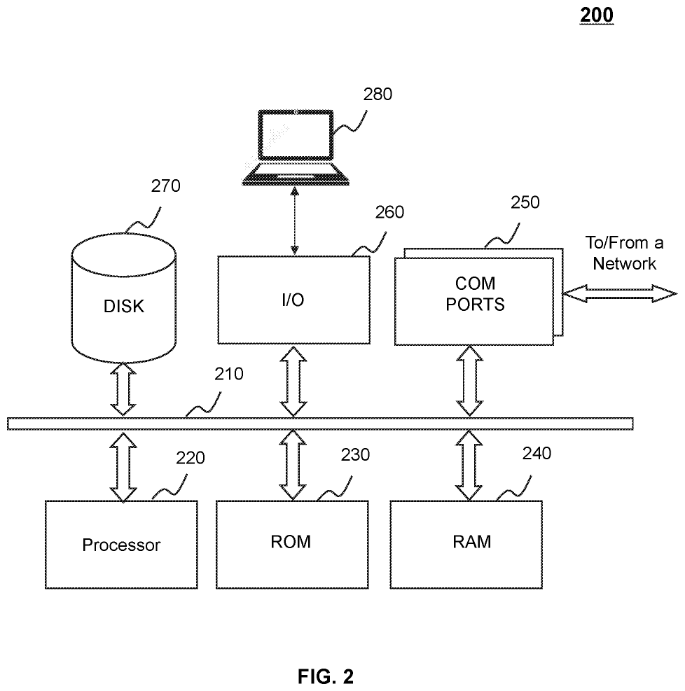

In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the one or more user terminals (e.g., the one or more requestor terminals 130, provider terminals 140), and/or the storage 150 via the network 120. As another example, the server 110 may be directly connected to the one or more user terminals (e.g., the one or more requestor terminals 130, provider terminals 140), and/or the storage 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data relating to the service request to perform one or more functions of the server 110 description in the present disclosure. For example, the processing engine 112 identifies a target region and may determine an evaluation result of a scheduling strategy based on historical service information associated with the target region. In some embodiments, the processing engine 112 may include one or more processing engines (e.g., signal-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the on-demand service system 110 (e.g., the server 110, the one or more requestor terminals 130, provider terminals 140, or the storage 150) may transmit information and/data to other component(s) of the on-demand service system 100 via the network 120. For example, the server 110 may receive a service request from the requestor terminal 130 via the network 120. In some embodiments, the network 120 may be any type of wired or wireless network, or any combination thereof. Merely by way of example, the network 120 may include a cable network, a wireline network, an optical fiber network, a tele communications network, an intranet, an internet, a local area network (LAN), a wide area network (WAN), a wireless local area network (WLAN), a metropolitan area network (MAN), a wide area network (WAN), a public telephone switched network (PTSN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-demand service system 100 may be connected to the network 120 to exchange data and/or information between them.

In some embodiments, a service requestor may be a user of the requestor terminal 130. In some embodiments, the user of the requestor terminal 130 may be someone other than the service requestor. For example, a user A of the requestor terminal 130 may use the requestor terminal 130 to send a service request for a user B, or receive service and/or information or instructions from the server 110. In some embodiments, a provider may be a user of the provider terminal 140. In some embodiments, the user of the provider terminal 140 may be someone other than the provider. For example, a user C of the provider terminal 140 may use the provider terminal 140 to receive a service request for a user D, and/or information or instructions from the server 110.

In some embodiments, the requestor terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, built-in device in the motor vehicle 130-4 may include an onboard computer, an onboard television, etc. In some embodiments, the requestor terminal 130 may be a device with positioning technology for locating the position of the service requestor and/or the requestor terminal 130.

In some embodiments, the provider terminal 140 may be similar to, or the same device as the requestor terminal 130. In some embodiments, the provider terminal 140 may be a device with positioning technology for locating the position of the driver and/or the provider terminal 140. In some embodiments, the requestor terminal 130 and/or the provider terminal 140 may communicate with other positioning device to determine the position of the service requestor, the requestor terminal 130, the driver, and/or the provider terminal 140. In some embodiments, the requestor terminal 130 and/or the provider terminal 140 may send positioning information to the server 110.

The storage 150 may store data and/or instructions. In some embodiments, the storage 150 may store data obtained from the one or more user terminals (e.g., the one or more passenger terminals 130, provider terminals 140). In some embodiments, the storage 150 may store data and/or instructions that the server 110 may execute or use to perform exemplary methods described in the present disclosure. In some embodiments, the storage 150 may include a mass storage, a removable storage, a volatile read-and-write memory, a read-only memory (ROM), or the like, or any combination thereof. Exemplary mass storage may include a magnetic disk, an optical disk, a solid-state drives, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 150 may be connected to the network 120 to communicate with one or more components of the on-demand service system 100 (e.g., the server 110, the requestor terminal 130, the provider terminal 140). One or more components of the on-demand service system 100 may access the data and/or instructions stored in the storage 150 via the network 120. In some embodiments, the storage 150 may be directly connected to or communicate with one or more components of the on-demand service system 100 (e.g., the server 110, the requestor terminal 130, the provider terminal 140). In some embodiments, the storage 150 may be part of the server 110.

In some embodiments, one or more components of the on-demand service system 100 (e.g., the server 110, the requestor terminal 130, the provider terminal 140) may access the storage 150. In some embodiments, one or more components of the on-demand service system 100 may read and/or modify information relating to the service requestor, provider, and/or the public when one or more conditions are met. For example, the server 110 may read and/or modify one or more users' information after a service. As another example, the provider terminal 140 may access information relating to the service requestor when receiving a service request from the requestor terminal 130, but the provider terminal 140 may not modify the relevant information of the service requestor.

In some embodiments, information exchanging of one or more components of the on-demand service system 100 may be achieved by way of requesting a service. The object of the service request may be any product. In some embodiments, the product may be a tangible product, or immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used on the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle), a car (e.g., a taxi, a bus, a private car), a train, a subway, a vessel, an aircraft (e.g., an airplane, a helicopter, a space shuttle, a rocket, a hot-air balloon), or the like, or any combination thereof.

FIG. 2 is a schematic diagram illustrating exemplary hardware and software components of a computing device 200 on which the server 110, the requestor terminals 130, or the provider terminals 140 may be implemented according to some embodiments of the present disclosure. For example, the processing engine 112 may be implemented on the computing device 200 and configured to perform functions of the processing engine 112 disclosed in this disclosure.

The computing device 200 may be used to implement any component of the on-demand service system 100 as described herein. For example, the processing engine 112 may be implemented on the computing device 200, via its hardware, software program, firmware, or a combination thereof. Although only one such computer is shown, for convenience, the computer functions relating to the on-demand service as described herein may be implemented in a distributed fashion on a number of similar platforms to distribute the processing load.

The computing device 200, for example, may include COM ports 250 connected to and from a network connected thereto to facilitate data communications. The computing device 200 may also include a processor (e.g., a processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The exemplary computing device may include an internal communication bus 210, program storage and data storage of different forms including, for example, a disk 270, and a read only memory (ROM) 230, or a random access memory (RAM) 240, for various data files to be processed and/or transmitted by the computing device. The exemplary computer platform may also include program instructions stored in the ROM 230, RAM 240, and/or other type of non-transitory storage medium to be executed by the processor 220. The methods and/or processes of the present disclosure may be implemented as the program instructions. The computing device 200 also includes an I/O component 260, supporting input/output between the computer and other components therein such as user interface elements 280. The computing device 200 may also receive programming and data via network communications.

The computing device 200 may also include a hard disk controller communicated with a hard disk, a keypad/keyboard controller communicated with a keypad/keyboard, a serial interface controller communicated with a serial peripheral equipment, a parallel interface controller communicated with a parallel peripheral equipment, a display controller communicated with a display, or the like, or any combination thereof.

Merely for illustration, only one processor is described in FIG. 2. Multiple processors are also contemplated, thus operations and/or method steps performed by one processor as described in the present disclosure may also be jointly or separately performed by the multiple processors. For example, if in the present disclosure the processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

One of ordinary skill in the art would understand that when an element of the on-demand service system 100 performs, the element may perform through electrical signals and/or electromagnetic signals. For example, when a requestor terminal 130 processes a task, such as making a determination, identifying or selecting an object, the requestor terminal 130 may operate logic circuits in its processor to process such task. When the requestor terminal 130 sends out a service request to the server 110, a processor of the service requestor terminal 130 may generate electrical signals encoding the service request. The processor of the requestor terminal 130 may then send the electrical signals to an output port. If the requestor terminal 130 communicates with the server 110 via a wired network, the output port may be physically connected to a cable, which may further transmit the electrical signals to an input port of the server 110. If the requestor terminal 130 communicates with the server 110 via a wireless network, the output port of the requestor terminal 130 may be one or more antennas, which may convert the electrical signals to electromagnetic signals. Similarly, a provider terminal 140 may process a task through operation of logic circuits in its processor, and receive an instruction and/or service request from the server 110 via electrical signals or electromagnet signals. Within an electronic device, such as the requestor terminal 130, the provider terminal 140, and/or the server 110, when a processor thereof processes an instruction, sends out an instruction, and/or performs an action, the instruction and/or action is conducted via electrical signals. For example, when the processor retrieves or saves data from a storage medium (e.g., the storage 150), it may send out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

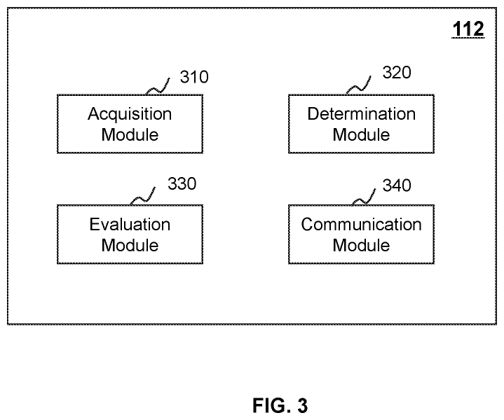

FIG. 3 is a block diagram illustrating an exemplary processing engine 112 according to some embodiments of the present disclosure. The processing engine 112 may include an acquisition module 310, a determination module 320, an evaluation module 330, and a communication module 340.

The acquisition module 310 may be configured to obtain historical service information associated with a target region. The acquisition module 310 may obtain the historical service information of a designated driving service from a storage device (e.g., the storage 150) disclosed elsewhere in the present disclosure. The designated driving service may refer to a service that allows a service requestor (e.g., a passenger) to online hire and/or designate a service provider (e.g., a driver), so that the service provider could come to the service requestor's place and use the service requestor's equipment (e.g., the passenger's vehicle) to provide a service (e.g., drive the passenger to a destination designated by the passenger). The target region may be a specific location or an area. The target region may be a region where service demand may be substantially higher than supply (e.g., a central business district).

The historical service information may include a number of cancelled historical service requests in the target region, a number of historical service requests with no response in the target region, a number of completed historical service requests, etc. As used herein, the term “completed historical service request” also may be referred to as “historical service order”.

The determination module 320 may be configured to determine a scheduling strategy associated with the target region. As used herein, the “scheduling strategy” may refer to a strategy based on which the processing engine 112 may schedule available service providers to the target region.

In some embodiments, the determination module 320 may further determine estimated service information based on the historical service information associated with the target region and the scheduling strategy. The estimated service information may include a simulated number of cancelled service requests, a simulated number of service requests with no response, a simulated number of completed service requests, etc.

The evaluation module 330 may be configured to determine an evaluation result of the scheduling strategy based on the estimated service information and the historical service information. For example, in response to a determination that a difference between the estimated service information (e.g., the simulated number of completed service requests) and the historical service information (e.g., the number of completed historical service requests) is larger than a threshold (e.g., 5%), the evaluation module 330 may determine that the scheduling strategy has a better service providing result than the historical service information.

The communication module 340 may be configured to output the evaluation result of the scheduling strategy and/or any data associated with the scheduling strategy to a device associated with the on-demand service system 100 (e.g., the storage 150, an external device). In some embodiments, the communication module 340 may receive any instruction associated with the scheduling strategy. For example, the communication module 340 may receive an instruction for evaluating a specific scheduling strategy from a user and further transmit the instruction to the determination module 320 and/or the evaluation module 330.

The modules in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined into a single module, and any one of the modules may be divided into two or more units. For example, the acquisition module 310 and the determination module 320 may be combined as a single module which may both obtain historical service information and determine estimated service information. As another example, the determination module 320 and the evaluation module 330 may be combined as a single module which may both determine estimated service information based on the scheduling strategy and evaluate the scheduling strategy based on the estimated service information. As a further example, the processing engine 112 may include a storage module (not shown) used to store information and/or data associated with the historical service information, the scheduling strategy, the estimated service information, the evaluation result of the scheduling strategy, etc.

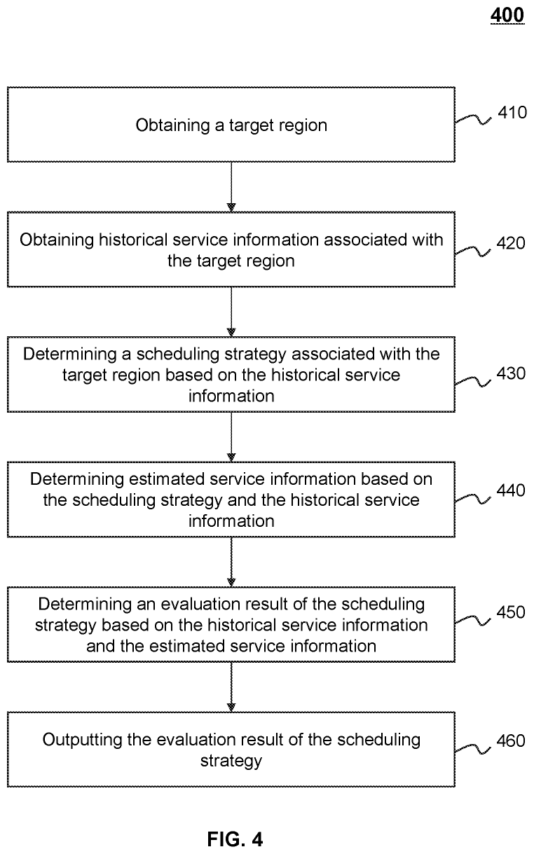

FIG. 4 is a flowchart illustrating an exemplary process 400 for evaluating a scheduling strategy associated with a designated driving service according to some embodiments of the present disclosure. The process 400 may be executed by the on-demand service system 100. For example, the process 400 may be implemented as a set of instructions (e.g., an application) stored in the storage ROM 230 or RAM 240. The processor 220 and/or the modules in FIG. 3 may execute the set of instructions, and when executing the instructions, it may be configured to perform the process 400. The operations of the illustrated process presented below are intended to be illustrative. In some embodiments, the process 400 may be accomplished with one or more additional operations not described and/or without one or more of the operations discussed. Additionally, the order in which the operations of the process as illustrated in FIG. 4 and described below is not intended to be limiting.

In 410, the processing engine 112 (e.g., the acquisition module 310) (e.g., the processing circuits of the processor 220) may obtain a target region.

The target region may be a specific location (e.g., a shopping mall) or an area (e.g., an area within a certain radius from a defined location). The processing engine 112 may determine the target region based on default settings of the system 100, or instructions from a user. In some embodiments, the target region may be a region where service demand may be substantially higher than supply (e.g., a central business district).

In 420, the processing engine 112 (e.g., the acquisition module 310) (e.g., the processing circuits of the processor 220) may obtain historical service information associated with the target region. As used herein, the service may be an online on-demand service. For example, the service may be an online on-demand transportation service. More specifically, the service may be an online on-demand designated driving service. As used herein, an online on-demand designated driving service may refer to a service that allows a service requestor (e.g., a passenger) to online hire and/or designate a service provider (e.g., a driver), so that the service provider could come to a designated location (e.g., the passenger's place) and use the service requestor's equipment (e.g., the passenger's vehicle) to provide a requested service (e.g., drive the passenger to a destination designated by the passenger). For example, when a passenger drinks too much alcohol to drive, the passenger may online hire a designated driver. Under the passenger's instruction, the driver may come to the bar or restaurant where the passenger drinks at a designated time to send the passenger to his/her hotel or home using the passenger's car.

In some embodiments, the historical service information may be information associated with historical service requests within a certain time period (e.g., the last 12 hours, the last day, the last week, 7:00 pm˜9:00 pm in the last week) occurred in the target region. The processing engine 112 may obtain the historical service information from a storage device (e.g., the storage 150) disclosed elsewhere in the present disclosure.

The historical service information may include a number of cancelled historical service requests in the target region, a number of historical service requests with no response in the target region, a number of completed historical service orders in the target region, etc. In some embodiments, the historical service information may further include a cancellation rate of historical service requests, a rate of historical service request with no response, a completion rate of historical service requests, etc. As used herein, the cancellation rate of historical service requests may refer to a radio of the number of cancelled historical service requests to a number of initiated historical service requests in the target region. The rate of historical service request with no response may refer to a ratio of the number of historical service requests with no response to the number of initiated historical service requests in the target region. The completion rate of historical service requests may refer to a ratio of the number of completed historical service orders to the number of initiated historical service requests in the target region.

In some embodiments, the historical service may further include historical user information. The historical user information may include, for example, a user identifier, a name, a nickname, a gender, an age, a telephone number, an occupation, a driving experience, a vehicle age, a license plate number, a driver's license number, a certification status, etc.

In 430, the processing engine 112 (e.g., the determination module 320) (e.g., the processing circuits of the processor 220) may determine a scheduling strategy associated with the target region. As used herein, the “scheduling strategy” may refer to a strategy based on which the processing engine 112 may schedule available service providers to the target region. The scheduling strategy may include one or more scheduling parameters, for example, a number of available service providers to be scheduled, a region where the available service providers are within, etc.

For example, assuming that the target region is a rectangular region, the scheduling strategy may be that scheduling a certain amount (e.g., 10) of available service providers (e.g., drivers) nearby a side of the rectangular region into the target region. As used herein, “nearby” may refer to that a distance between a location of a service provider and the side is less than a threshold (e.g., 500 meters). As another example, assuming that the target region is a circular region with a first radius (e.g., 2 km) from a center location, the scheduling strategy may be scheduling a certain amount (e.g., 10) of available service providers (e.g., drivers) within a second radius (e.g., 3 km) from the center location into the target region.

In some embodiments, the processing engine 112 may determine the scheduling strategy based on the historical service information associated with the target region. For example, assuming that the number of initiated historical service requests is 100 and the number of historical service requests with no response is 50, the processing engine 112 may determine the number of available service providers to be scheduled as a value 50.

In 440, the processing engine 112 (e.g., the determination module 320 or the evaluation module 330) (e.g., the processing circuits of the processor 220) may determine estimated service information based on the scheduling strategy and the historical service information. As used herein, the estimated service information may be simulated service information within the same time period with that of the historical service information, which may be obtained by assuming that one or more available service providers had been scheduled to the target region based on the scheduling strategy.

The estimated service information may include a simulated number of cancelled service requests in the target region, a simulated number of service requests with no response in the target region, a simulated number of completed service requests in the target region, etc. In some embodiments, the estimated service information may further include a simulated cancellation rate of service requests, a simulated rate of service requests with no response, a simulated completion rate of service requests, etc. As used herein, the simulated cancellation rate of service requests may refer to a radio of the simulated number of cancelled service requests to the number of initiated historical service requests in the target region. The simulated rate of service requests with no response may refer to a ratio of the simulated number of service requests with no response to the number of initiated historical service requests in the target region. The simulated completion rate of service requests may refer to a ratio of the simulated number of completed service requests to the number of initiated historical service requests in the target region.

In some embodiments, the processing engine 112 may determine the estimated service information based on a machine learning model (e.g., a neural network model, a logistic regression model, a random forest model, etc.). The processing engine 112 may train the machine learning model based on the historical service information. In some embodiments, the processing engine 112 may determine the estimated service information based on a simulation algorithm.

In 450, the processing engine 112 (e.g., the evaluation module 330) (e.g., the processing circuits of the processor 220) may determine an evaluation result of the scheduling strategy based on the historical service information and the estimated service information. For example, the processing engine 112 may compare the estimated service information with the historical service information to determine whether the scheduling strategy has a better service providing result than the historical service information.

For example, the historical service information may be expressed as a first dataset including a plurality of historical parameters associated with historical service requests illustrated as formula (1) below:

H={X₂,Xᵢ, . . . , Xₙ} (1)

where Xᵢ refers to a historical parameter associated with historical service requests (e.g., the number of initiated historical service requests in the target region, the number of completed historical service requests in the target region, the number of cancelled historical service requests in the target region, the number of historical service requests with no response in the target region, the completion rate of historical service requests, etc.).

Accordingly, the estimated service information may be expressed as a second dataset including a plurality of estimated parameters illustrated as formula (2) below:

E={Y₁,Y₂,Y, . . . , Yₙ} (2)

where Yᵢ refers to an estimated parameter associated with estimated service requests (e.g., the simulated number of completed service requests, the simulated number of cancelled service requests, the simulated number of service requests with no response, the simulated completion rate of service requests, etc.).

The processing engine 112 may compare the first dataset with the second dataset to determine whether the scheduling strategy has a better service providing result.

In some embodiments, the processing engine 112 may select one historical parameter (e.g., the number of cancelled historical service requests) from the plurality of historical parameters and compare it with a corresponding estimated parameters (e.g., the simulated number of cancelled service requests).

For example, the processing engine 112 may compare the number of cancelled historical service requests with the simulated number of cancelled service requests. In response to the determination that the simulated number of cancelled service requests is less than the number of cancelled historical service requests, the processing engine 112 may determine that the scheduling strategy has a better service providing result than the historical service information.

As another example, the processing engine 112 may compare the number of historical service requests with no response with the simulated number of service requests with no response. In response to the determination that the simulated number of service requests with no response is less than the number of historical service requests with no response, the processing engine 112 may determine that the scheduling strategy has a better service providing result than the historical service information.

As a further example, the processing engine 112 may compare the number of completed historical service requests with the simulated number of completed service requests. In response to the determination that the simulated number of completed service requests is larger than the number of completed historical service requests, the processing engine 112 may determine that the scheduling strategy has a better service providing result than the historical service information.

The above description is only provided for illustration purposes, and not intended to limit the scope of the present disclosure. The processing engine 112 may also compare other historical parameters (e.g., the completion rate of historical service requests) with corresponding estimated parameters (e.g., the simulated completion rate of service requests). For example, in response to the determination that the simulated completion rate of service requests is larger than the completion rate of historical service requests, the processing engine 112 may determine that the scheduling strategy has a better service providing result than the historical service information.

In some embodiments, the processing engine 112 may select one historical parameter (e.g., the number of cancelled historical service requests) from the plurality of historical parameters and compare it with a corresponding estimated parameters (e.g., the simulated number of cancelled service requests) according to formula (3) below:

$${D}_{i} = \frac{\vert {Y}_{i} - {X}_{i} \vert}{{X}_{i}} \qquad ( 3 )$$

where Dᵢ refers to a difference between the estimated service information and the historical service information.

For example, the processing engine 112 may determine a first difference between the number of cancelled historical service requests and the simulated number of cancelled service requests according to formula (4) below:

$${D}_{1} = \frac{\vert {C}_{Y} - {C}_{X} \vert}{{C}_{X}} \qquad ( 4 )$$

where D₁ refers to the first difference, C_{Y} refers to the simulated number of cancelled service requests, and C_{X} refers to the number of cancelled historical service requests.

As another example, the processing engine 112 may determine a second difference between the number of historical service requests with no response and the simulated number of service requests with no response according to formula (5) below:

$${D}_{2} = \frac{\vert {R}_{Y} - {R}_{X} \vert}{{R}_{X}} \qquad ( 5 )$$

where D₂ refers to the second difference, R_{Y} refers to the simulated number of service requests with no response, and R_{X} refers to the number of historical service requests with no response.

As a further example, the processing engine 112 may determine a third difference between the number of completed historical service requests and the simulated number of completed service requests according to formula (6) below:

$${D}_{3} = \frac{\vert {P}_{Y} - {P}_{X} \vert}{{P}_{X}} \qquad ( 6 )$$

where D₃ refers to the third difference, P_{Y} refers to the simulated number of completed service requests, and P_{X} refers to the number of completed historical service requests.

The processing engine 112 may further determine whether the first difference, the second difference, or the third difference is larger than a threshold (e.g., 10%). In response to a determination that the difference is larger than the threshold, the processing engine 112 may determine that the scheduling strategy has a better service providing result than the historical service information.

In some embodiments, the processing engine 112 may assign a weighting coefficient to each of the first difference, the second difference, and the third difference. Further, the processing engine 112 may select at least two of the first difference, the second difference, or the third difference, and determine a weighted value based on their respective weighting coefficients.

For example, the processing engine 112 may determine a weighted value of the first difference, the second difference, and the third difference according to formula (7) below:

D=w₁×D₁+w₂×D₂+w₃×D₃ (7)

where D refers to the weighted value, w₁ refers to a first weighting coefficient corresponding to the first difference, w₂ refers to a second weighting coefficient corresponding to the second difference, and w₃ refers to a third weighting coefficient corresponding to the third difference. The weighting coefficients including w₁, w₂, and w₃ may be default settings of the system 100 (e.g., 0.5, 0.3, and 0.2 respectively), or may be adjustable under different situations.

The processing engine 112 may further determine whether the weighted value is larger than a threshold (e.g., 10%). In response to a determination that the weighted value is larger than the threshold, the processing engine 112 may determine that the scheduling strategy has a better service providing result than the historical service information.

In some embodiments, the processing engine 112 may rank at least two of the first difference, the second difference, or the third difference, and select one (e.g., the maximum one, the second maximum one, the minimum one) of the ranked at least two of the first difference, the second difference, or the third difference. Further, the processing engine 112 may determine whether the selected one is larger than a threshold (e.g., 10%). In response to a determination that the selected one is larger than the threshold, the processing engine 112 may determine that the scheduling strategy has a better service providing result than the historical service information.

It should be noted that the difference described above is only provided for illustration purposes, the processing engine 112 may also determine other differences (e.g., a difference between the simulated completion rate of service requests and the completion rate of historical service requests) between the estimated service information and the historical service information. It also should be noted that the threshold(s) mentioned above may be default settings of the system 100, or may be adjustable under different situations.

In 460, the processing engine 112 (e.g., the communication module 340) (e.g., the interface circuits of the processor 220) may output the evaluation result of the scheduling strategy. For example, the processing engine 112 may store the evaluation result in a storage device (e.g., the storage 150) disclosed elsewhere in the present disclosure. As another example, the processing engine 112 may transmit data associated with the scheduling strategy to an external device (not shown) associated with the on-demand service system 100.

In some embodiments, the processing engine 112 may determine a plurality of scheduling strategies and evaluate the plurality of scheduling strategies based on the historical service information and corresponding estimated service information. The processing engine 112 may further select one from the plurality of scheduling strategies as a target scheduling strategy for the target region based on the evaluation result. For example, the processing engine 112 may select a first scheduling strategy associated with the highest difference from the historical service information as the target scheduling strategy.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 400. In the storing step, the processing engine 112 may store information and/or data associated with the target region (e.g., the historical service information, the scheduling strategy, the estimated service information, the evaluation result of the scheduling strategy) in a storage device (e.g., the storage 150) disclosed elsewhere in the present disclosure.

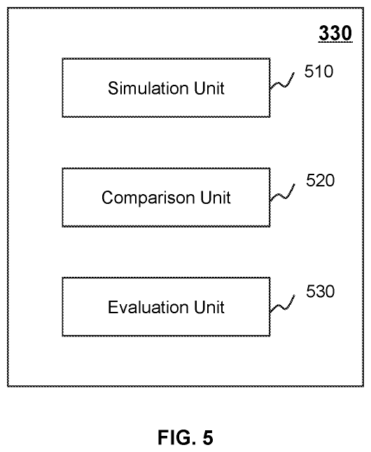

FIG. 5 is a block diagram illustrating an exemplary evaluation module 330 according to some embodiments of the present disclosure. The evaluation module 330 may include a simulation unit 510, a comparison unit 520, and an evaluation unit 530.

The simulation unit 510 may be configured to determine the estimated service information based on the scheduling strategy and the historical service information. In some embodiments, the simulation unit 510 may determine the estimated service information based on a machine learning model or a simulation algorithm.

The comparison unit 520 may be configured to compare the estimated service information with the historical service information, and determine a difference between the estimated service information and the historical service information (e.g., the first difference, the second difference, or the third difference described in FIG. 4).

The evaluation unit 530 may be configured to evaluate the scheduling strategy based on the difference between the estimated service information and the historical service information. For example, the evaluation unit 530 may determine whether the difference is larger than a threshold. In response to the determination that the difference is larger than the threshold, the evaluation unit 530 may determine that the scheduling strategy has a better service providing result than the historical service information.

The units in the evaluation module 330 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the units may be combined into a single module, and any one of the units may be divided into two or more sub-units.

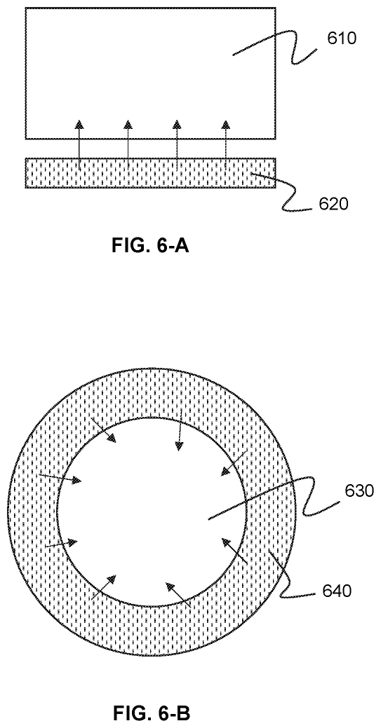

FIG. 6-A and FIG. 6-B are schematic diagrams illustrating an exemplary scheduling strategy according to some embodiments of the present disclosure. As illustrated in FIG. 6-A, a rectangular region 610 refers to the target region. A scheduling strategy may be scheduling a certain amount of available service providers located in a shadow area 620 to the target region. As illustrated in FIG. 6-B, a circular region 630 refers to the target region. A scheduling strategy may be scheduling a certain amount of available service providers located in a shadow area 640 to the target region.

It should be noted that the above description is merely provided for the purposes of illustration, the scheduling strategy may be scheduling available service provides located elsewhere nearby the target region to the target region.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

1. A system, comprising:
at least one storage medium including a set of instructions for scheduling service of an on-demand service; and
at least one processor in communication with the at least one storage medium, wherein when executing the set of instructions, the at least one processor is configured to cause the system to:
obtain historical service information of the on-demand service associated with a target region;
determine a scheduling strategy to schedule service providers to the target region based on the historical service information;
determine estimated service information associated with the target region based on the scheduling strategy and the historical service information;
determine whether the scheduling strategy has a better service providing result than a service providing condition of the historical service information; and
store the scheduling strategy in the at least one storage medium in response to a determination that the scheduling strategy has a better service providing result than the service providing condition of the historical service information.

2. The system of claim 1, wherein the historical service information includes:
count of cancelled historical service requests in the target region,
count of historical service requests with no response in the target region, or
count of completed historical service requests in the target region.

3. The system of claim 2, wherein the estimated service information includes:
a simulated count of cancelled service requests in the target region,
a simulated count of service requests with no response in the target region, or
a simulated count of completed service requests in the target region.

4. The system of claim 3, wherein to determine whether the scheduling strategy has a better service providing result than a service providing condition of the historical service information, the at least one processor is further configured to cause the system to determine at least one of:
a first difference between the simulated count of cancelled service requests and the count of historical cancelled service requests,
a second difference between the simulated count of service requests with no response and the count of historical service requests with no response, or
a third difference between the simulated count of completed service requests and the count of completed historical service requests.

5. The system of claim 4, wherein to determine whether the scheduling strategy has a better service providing result than a service providing condition of the historical service information, the at least one processor is further configured to cause the system to:
determine a weighted value of at least two of the first difference, the second difference, or the third difference; and
determine whether the scheduling strategy has a better service providing result than the service providing condition of the historical service information based on the weighted value.

6. The system of claim 4, wherein to determine whether the scheduling strategy has a better service providing result than a service providing condition of the historical service information, the at least one processor is further configured to cause the system to:
rank at least two of the first difference, the second difference, or the third difference;
select one of the ranked at least two of the first difference, the second difference, or the third difference; and
determine whether the scheduling strategy has a better service providing result than the service providing condition of the historical service information based on the selected one of the first difference, the second difference, or the third difference.

7. The system of claim 3, wherein to determine whether the scheduling strategy has a better service providing result than a service providing condition of the historical service information, the at least one processor is further configured to cause the system to:
determine whether the simulated count of cancelled service requests is less than the count of cancelled historical service requests; and
in response to the determination that the simulated count of cancelled service requests is less than the count of cancelled historical service requests, determine that the scheduling strategy has a better service providing result than the service providing condition of the historical service information.

8. The system of claim 3, wherein to determine whether the scheduling strategy has a better service providing result than a service providing condition of the historical service information, the at least one processor is further configured to cause the system to:
determine whether the simulated count of service requests with no response is less than the count of historical service requests with no response; and
in response to the determination that the simulated count of service requests with no response is less than the count of historical service requests with no response, determine that the scheduling strategy has a better service providing result than the service providing condition of the historical service information.

9. The system of claim 3, wherein to determine whether the scheduling strategy has a better service providing result than a service providing condition of the historical service information, the at least one processor is further configured to cause the system to:
determine whether the simulated count of completed service requests is larger than the count of completed historical service requests; and
in response to the determination that the simulated count of completed service requests is larger than the count of completed historical service requests, determine that the scheduling strategy has a better service providing result than the service providing condition of the historical service information.

10. The system of claim 1, wherein the on-demand service is a designated driving service that allows a service requestor to designate a service provider online, so that the service provider could come to the service requestor's place and use the service requestor's equipment to provide the service.

11. A method implemented on a computing device having at least one processor, at least one storage medium, and a communication platform connected to a network, the method comprising:
obtaining historical service information of the on-demand service associated with a target region;
determining a scheduling strategy to schedule service providers to the target region based on the historical service information;
determining estimated service information associated with the target region based on the scheduling strategy and the historical service information;
determining whether the scheduling strategy has a better service providing result than a service providing condition of the historical service information; and
storing the scheduling strategy in the at least one storage medium in response to a determination that the scheduling strategy has a better service providing result than the service providing condition of the historical service information.

12. The method of claim 11, wherein the historical service information includes:
count of cancelled historical service requests in the target region,
count of historical service requests with no response in the target region, or
count of completed historical service requests in the target region.

13. The method of claim 12, wherein the estimated service information includes:
a simulated count of cancelled service requests in the target region,
a simulated count of service requests with no response in the target region, or
a simulated count of completed service requests in the target region.

14. The method of claim 13, wherein the determining whether the scheduling strategy has a better service providing result than a service providing condition of the historical service information further comprises determining at least one of:
a first difference between the simulated count of cancelled service requests and the count of historical cancelled service requests,
a second difference between the simulated count of service requests with no response and the count of historical service requests with no response, or
a third difference between the simulated count of completed service requests and the count of completed historical service requests.

15. The method of claim 14, wherein the determining whether the scheduling strategy has a better service providing result than a service providing condition of the historical service information further comprises:
determining a weighted value of at least two of the first difference, the second difference, or the third difference; and
determining whether the scheduling strategy has a better service providing result than the service providing condition of the historical service information based on the weighted value.

16. The method of claim 14, wherein the determining whether the scheduling strategy has a better service providing result than a service providing condition of the historical service information further comprises:
ranking at least two of the first difference, the second difference, or the third difference;
selecting one of the ranked at least two of the first difference, the second difference, or the third difference; and
determining whether the scheduling strategy has a better service providing result than the service providing condition of the historical service information based on the selected one of the first difference, the second difference, or the third difference.

17. The method of claim 13, wherein the determining whether the scheduling strategy has a better service providing result than a service providing condition of the historical service information further comprises:
determining whether the simulated count of cancelled service requests is less than the count of cancelled historical service requests; and
in response to the determination that the simulated count of cancelled service requests is less than the count of cancelled historical service requests, determining that the scheduling strategy has a better service providing result than the service providing condition of the historical service information.

18. The method of claim 13, wherein the determining whether the scheduling strategy has a better service providing result than a service providing condition of the historical service information further comprises:
determining whether the simulated count of service requests with no response is less than the count of historical service requests with no response; and
in response to the determination that the simulated count of service requests with no response is less than the count of historical service requests with no response, determining that the scheduling strategy has a better service providing result than the service providing condition of the historical service information.

19. The method of claim 13, wherein the determining whether the scheduling strategy has a better service providing result than a service providing condition of the historical service information further comprises:
determining whether the simulated count of completed service requests is larger than the count of completed historical service requests; and
in response to the determination that the simulated count of completed service requests is larger than the count of completed historical service requests, determining that the scheduling strategy has a better service providing result than the service providing condition of the historical service information.

20. The method of claim 11, wherein the on-demand service is a designated driving service that allows a service requestor to designate a service provider online, so that the service provider could come to the service requestor's place and use the service requestor's equipment to provide the service.

21. (canceled)
